(19) United States
(12) Patent Application Publication
(10) Pub. No.: US 2021/0270275 A1
(43) Pub. Date: Sep. 2, 2021

(54) COMPRESSOR WITH THRUST CONTROL

(71) Applicant: CARRIER CORPORATION, Palm Beach Gardens, FL (US)

(72) Inventor: Vishnu M. Sishtla, Manlius, NY (US)

(21) Appl. No.: 17/255,006

(22) PCT Filed: May 11, 2020
(86) PCT No.: PCT/US2020/032296

§ 371 Date: Dec. 22, 2020

Related U.S. Application Data
(60) Provisional application No. 62/846,026, filed on May 10, 2019.

(51) Int. Cl. F04D 25/06; F04D 17/12; F04D 29/051; H02K 1/12; H02K 1/22; H02K 7/08

(52) U.S. Cl. CPC F04D 25/06; F04D 17/12; F04D 29/051; H02K 2213/03; H02K 1/22; H02K 7/083; H02K 1/12

(57) ABSTRACT

An electric motor includes a stator and a rotator that is configured to rotate with respect to the stator. The stator has a length Ls and the rotor has a length Lr. The length Lr of the rotor is less than the length Ls of the stator such that the rotor does not overhang the stator. A compressor and a method of compressing a fluid are also disclosed.

### CROSS-REFERENCE TO RELATED APPLICATIONS

This application claims priority to U.S. Provisional Application No. 62/846,026, which was filed on May 10, 2019, and is incorporated by reference herein in its entirety.

### BACKGROUND

Compressors compress fluid by rotation of one or more impellers via a shaft. In a centrifugal compressor, for example, the shaft and impellers can be rotated by a motor, such as an electric motor. In a centrifugal compressor, for example, the impellers impart kinetic energy to the fluid, then, the fluid passes through a diffuser, which slows the flow of the fluid and converts the kinetic energy into an increase in pressure (e.g., compression).

During operation of compressors, forces generated within the compressor can cause compressor components to become misaligned with one another. Misalignment can cause wear and reduce the lifetime of certain compressor components.

### SUMMARY

An electric motor according to an example of this disclosure includes a stator and a rotator that is configured to rotate with respect to the stator. The stator has a length Ls and the rotor has a length Lr. The length Lr of the rotor is less than the length Ls of the stator such that the rotor does not overhang the stator.

In a further example of the foregoing embodiment, the difference between the length Lr of the rotor and the length Ls of the stator is between about 1 and 5% of the length Lr of the rotor.

In a further example of any of the foregoing embodiments, the difference between the length Lr of the rotor and the length Ls of the stator is between about 1 and 3% of the length Lr of the rotor.

In a further example of any of the foregoing embodiments, the difference between the length Lr of the rotor and the length Ls of the stator is about 1.5% of the length Lr of the rotor.

In a further example of any of the foregoing embodiments, the difference between the length Lr of the rotor and the length Ls of the stator is between about 2 and 5 times a predetermined manufacturing tolerance value for the length Lr of the rotor.

In a further example of any of the foregoing embodiments, the difference between the length Lr of the rotor and the length Ls of the stator is between about 2 and 3 times the predetermined manufacturing tolerance value for the length Lr of the rotor.

In a further example of any of the foregoing embodiments, the electric motor is an electric motor in a compressor, and the electric motor is configured to drive at least one impeller via a shaft.

A compressor according to an example of this disclosure includes an electric motor, a stator, and a rotor configured to rotate with respect to the stator. The stator has a length Ls and the rotor has a length Lr. The length Lr of the rotor is less than the length Ls of the stator. At least one impeller is configured to be driven by the electric motor via a shaft. At least one bearing is configured to facilitate rotation of the shaft.

In a further example of the foregoing embodiment, the compressor is a centrifugal compressor.

In a further example of any of the foregoing embodiments, the compressor is configured to compress a fluid, and the fluid is refrigerant.

In a further example of any of the foregoing embodiments, the difference between the length Lr of the rotor and the length Ls of the stator is between about 1 and 5% of the length Lr of the rotor.

In a further example of any of the foregoing embodiments, the difference between the length Lr of the rotor and the length Ls of the stator is between about 1 and 3% of the length Lr of the rotor.

In a further example of any of the foregoing embodiments, the difference between the length Lr of the rotor and the length Ls of the stator is about 1.5% of the length Lr of the rotor.

In a further example of any of the foregoing embodiments, the difference between the length Lr of the rotor and the length Ls of the stator is between about 2 and 5 times a predetermined manufacturing tolerance value for the length Lr of the rotor.

In a further example of any of the foregoing embodiments, the difference between the length Lr of the rotor and the length Ls of the stator is between about 2 and 3 times the predetermined manufacturing tolerance value for the length Lr of the rotor.

In a further example of any of the foregoing embodiments, at least one balance piston is configured to balance aerodynamic forces on the shaft, and the aerodynamic forces are generally aligned with an axis of the compressor.

In a further example of any of the foregoing embodiments, a sum of electromagnetic forces generated by the electric motor in a direction generally aligned with the axis are less than about 10% of the aerodynamic forces.

A method of compressing a fluid according to an example of this disclosure includes rotating an impeller with an electric motor, the impeller is configured to compress a fluid. The electric motor includes a stator and a rotor that is configured to rotate with respect to the stator. The stator has a length Ls and the rotor has a length Lr. The length Lr of the rotor is less than the length Ls of the stator when the rotor rotates.

In a further example of the foregoing method, the electric motor rotates the impeller via a shaft, and at least one bearing facilitates rotation of the shaft.

In a further example of any of the foregoing methods, the fluid is refrigerant.

### BRIEF DESCRIPTION OF THE DRAWINGS

FIG. 1 schematically illustrates a compressor.

FIG. 2 schematically illustrates a detail view of a motor of the compressor of FIG. 1.

### DETAILED DESCRIPTION

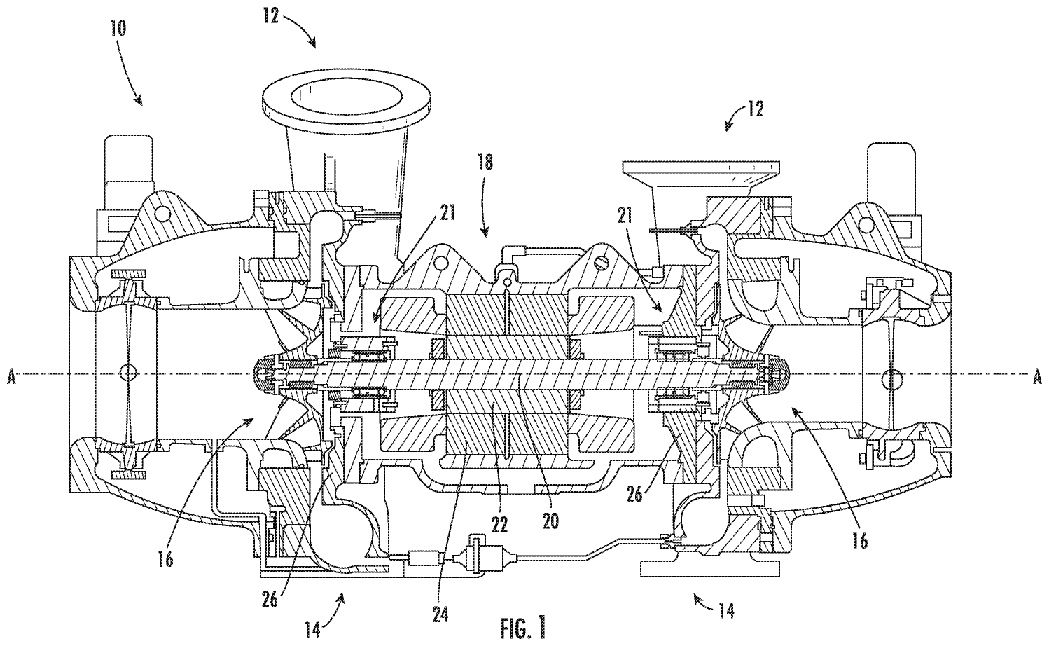

An example compressor 10 is schematically shown in FIG. 1. In this example, the compressor 10 is a centrifugal compressor, though other compressors are contemplated by this disclosure. The compressor 10 includes suction (inlet) ports 12 and discharge (outlet) ports 14. The compressor 10 includes one or more impellers 16 which rotate to draw fluid from the suction ports 12 and compressor the fluid. An example fluid is refrigerant.

An electric motor 18 drives the impellers 16 via a shaft 20. Bearings 21 facilitate rotation of the shaft 20. In this example, the compressor 10 includes one shaft 20 that drives two impellers 16, each of which is associated with a suction port 12 and a discharge port 14, though other arrangements are contemplated.

The motor 18 includes a stator 22 and a rotor 24. As is generally known, the stator 22 remains stationary while the rotor 24 rotates due to electromagnetic forces generated by the interaction of the rotor 24 and stator 22. The rotor 24 rotates the shaft 20, which in turn rotates the impellers 16 as discussed above.

During operation of the compressor 10, axial forces, e.g., those generally aligned with an axis A of the compressor 10, are generated by aerodynamic forces and electromagnetic forces. These axial forces are represented by vectors which are additive and together can be characterized as a “net thrust” of the compressor 10. The axial forces can cause various components of the compressor 10 to be urged out of alignment with one another. This in turn can cause stress and wear on the bearings 21, especially where the fluid is a low viscosity fluid like refrigerant. Accordingly, reducing the axial forces (e.g., reducing “net thrust”) improves bearing 21 life, and in some cases, permits the use of smaller bearings 21.

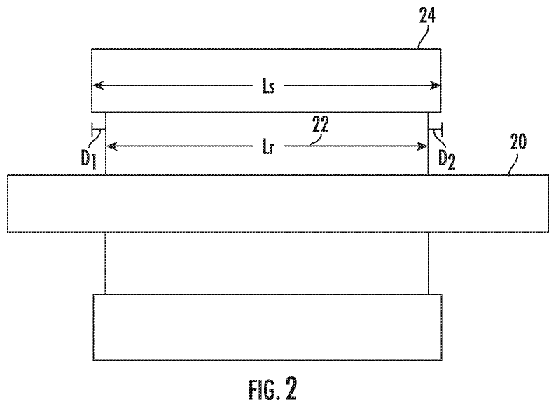

The aerodynamic axial forces are generated by fluid travelling through the compressor 10 and being compressed. In one example, aerodynamic axial forces are managed or reduced by balance pistons 26 on the shaft 20. In the example of FIG. 2, there is one balance piston 26 associated with each impeller 16, though more or less balance pistons 26 could be used. The balance pistons 26 are arranged and sized in such a way that they balance aerodynamic axial forces exerted on the shaft 20 to reduce overall axial aerodynamic forces within the compressor 10.

The electromagnetic axial forces are generated by misalignment of the rotor 24 with respect to the stator 22. Misalignment can be caused by shifting of the rotor 24 and stator 22 during operation of the motor 18 and/or mismatch in rotor 24 and stator 22 sizes due to manufacturing tolerances. In particular, electromagnetic axial forces are increased when the rotor 24 overhangs the stator 22 on either side. That is, during operation, the rotor 24 may shift from being centered with respect to the stator 22 in either axial direction so that overhang occurs on one side of the rotor 24. The amount of overhang may additionally or alternatively be caused by mismatch in rotor 24 and stator 22 length due to manufacturing tolerances, e.g., where the rotor 24 is slightly longer than the stator 22.

FIG. 2 shows a detail view of the motor 18. As shown, the rotor 24 has a length Lr that is less than a length Ls of the stator 22. The length Ls is selected so that overhang of the rotor 24 as discussed above is minimized Instead, the stator 22 overhangs the rotor 24 by a distance D1 and D2 on either side as shown in FIG. 2 when the rotor 24 is centered with respect to the stator 22. Accordingly, a difference Δ between the length Lr of the rotor 24 and the length Ls of the stator 22 is equal to the sum of D1 and D2. Because the length Lr of the rotor 24 is less than a length Ls of the stator 22, neither axial shifting of the rotor 24 with respect to the stator 22 nor manufacturing tolerances cause overhang.

In a particular example, the difference Δ is between about 1 and 5% of the length Lr of the rotor 24. For instance, if the rotor 24 has a length of 10 inches (25.4 cm), the difference Δ is between about 0.1 inches (2.54 mm) and 0.5 inches (12.7 mm), and the length of the stator 22 is between about 9.9 inches (25.1 cm) and 9.5 inches (24.1 cm).

In a more particular example, the difference Δ is between about 1% and 3% of the length Lr of the rotor 24.

In a more particular example, the difference Δ is about 1.5% of the length Lr of the rotor 24.

In another example, the difference Δ is between about 2 and 5 times the manufacturing tolerance for the length of the rotor 24. The manufacturing tolerance for the length of the rotor 24 is a predetermined tolerance value. For instance, if the rotor 24 is manufactured with a specification that it must be within 0.1 inches (2.54 mm) of a desired length Lr of the rotor 24, the difference Δ is between about 0.2 (5.08 mm) and 0.3 inches (7.62 mm) in this example.

In a more particular example, the difference Δ is between about 2 and 3 times the manufacturing tolerance for the length of the rotor 24.

The compressor 10 having stator 22 and rotor 24 with a difference Δ in their respective lengths as discussed above results in lower electromagnetic axial forces because the difference Δ ensures that the rotor 24 does not overhang the stator 22. As a result, the bearing 21 experiences less stress and wear. Therefore, the bearing 21 lifetime is improved, and in some cases, a smaller bearing 21 can be used.

In one example, the compressor 10 having stators 22 and rotors 24 with a difference Δ in their respective lengths as discussed above results in electromagnetic axial forces that are about 10% or less of the aerodynamic axial forces discussed above.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. An electric motor, comprising:
a stator; and
a rotor configured to rotate with respect to the stator, wherein the stator has a length Lₛ and the rotor has a length Lᵣ, and wherein the length Lᵣ of the rotor is less than the length Lₛ of the stator such that the rotor does not overhang the stator.

2. The electric motor of claim 1, wherein a difference between the length Lᵣ of the rotor and the length Ls of the stator is between about 1 and 5% of the length Lr of the rotor.

3. The electric motor of claim 2, wherein the difference between the length Lᵣ of the rotor and the length Ls of the stator is between about 1 and 3% of the length Lr of the rotor.

4. The electric motor of claim 3, wherein the difference between the length Lᵣ of the rotor and the length Lₛ of the stator is about 1.5% of the length Lᵣ of the rotor.

5. The electric motor of claim 1, wherein the difference between the length Lᵣ of the rotor and the length Lₛ of the stator is between about 2 and 5 times a predetermined manufacturing tolerance value for the length Lr of the rotor.

6. The electric motor of claim 5, wherein the difference between the length Lr of the rotor and the length Lₛ of the stator is between about 2 and 3 times the predetermined manufacturing tolerance value for the length Lᵣ of the rotor.

7. The electric motor of claim 1, wherein the electric motor is an electric motor in a compressor, and the electric motor is configured to drive at least one impeller via a shaft.

8. A compressor, comprising:
an electric motor, including:
a stator; and
a rotor configured to rotate with respect to the stator, wherein the stator has a length Lₛ and the rotor has a length Lᵣ, and wherein the length Lᵣ of the rotor is less than the length Lₛ of the stator;
at least one impeller configured to be driven by the electric motor via a shaft; and
at least one bearing configured to facilitate rotation of the shaft.

9. The compressor of claim 8, wherein the compressor is a centrifugal compressor.

10. The compressor of claim 8, wherein the compressor is configured to compress a fluid, and the fluid is refrigerant.

11. The compressor of claim 8, wherein a difference between the length Lr of the rotor and the length Lₛ of the stator is between about 1 and 5% of the length Lᵣ of the rotor.

12. The compressor of claim 11, wherein the difference between the length Lᵣ of the rotor and the length Lₛ of the stator is between about 1 and 3% of the length Lr of the rotor.

13. The compressor of claim 12, wherein the difference between the length Lᵣ of the rotor and the length Lₛ of the stator is about 1.5% of the length Lr of the rotor.

14. The compressor of claim 8, wherein the difference between the length Lr of the rotor and the length Lₛ of the stator is between about 2 and 5 times a predetermined manufacturing tolerance value for the length Lᵣ of the rotor.

15. The compressor of claim 14, wherein the difference between the length Lᵣ of the rotor and the length Lₛ of the stator is between about 2 and 3 times the predetermined manufacturing tolerance value for the length Lᵣ of the rotor.

16. The compressor of claim 8, further comprising at least one balance piston configured to balance aerodynamic forces on the shaft, the aerodynamic forces generally aligned with an axis of the compressor.

17. The compressor of claim 16, wherein a sum of electromagnetic forces generated by the electric motor in a direction generally aligned with the axis are less than about 10% of the aerodynamic forces.

18. A method of compressing a fluid, comprising:
rotating an impeller with an electric motor, the impeller configured to compress a fluid, the electric motor including:
a stator; and
a rotor configured to rotate with respect to the stator, wherein the stator has a length Lₛ and the rotor has a length Lr, and wherein the length Lr of the rotor is less than the length Lₛ of the stator when the rotor rotates.

19. The method of claim 18, wherein electric motor rotates the impeller via a shaft, and wherein at least one bearing facilitates rotation of the shaft.

20. The method of claim 18, wherein the fluid is refrigerant.
